(19) United States
(12) Patent Application Publication
(10) Pub. No.: US 2025/0309734 A1
(43) Pub. Date: Oct. 2, 2025

(54) VEHICLE POWERTRAIN STRUCTURE

(71) Applicant: Mazda Motor Corporation, Hiroshima (JP)

(72) Inventor: Manabu Sugimoto, Aki-gun (JP)

(21) Appl. No.: 19/055,938

(22) Filed: Feb. 18, 2025

(30) Foreign Application Priority Data
Mar. 28, 2024 (JP) 2024-054353

(51) Int. Cl. H02K 11/33; B60L 1/00; B60L 15/00; H02K 7/116; H02K 11/00

(52) U.S. Cl. CPC H02K 11/33; B60L 1/003; B60L 15/007; H02K 7/116; H02K 11/0094

(57) ABSTRACT

To provide a vehicle powertrain structure capable of establishing an electromagnetic compatibility (EMC) measure and ensuring safety during a vehicle collision at the same time, a vehicle includes a drive system, a battery, and an inverter. The drive system includes a motor for vehicle travel and a motor housing made of a conductive material. The battery is a power source of the motor. The inverter has a circuit section and an inverter housing. The inverter housing is tightly joined to the motor housing. The motor housing has a direct current (DC) connector that is disposed in a rear wall portion, and has a DC bus bar and a ferrite core accommodated in a housing inner space. The DC bus bar connects the circuit section of the inverter and the DC connector. The ferrite core is a noise filter that is inserted in the DC bus bar.

### TECHNICAL FIELD

The present invention relates to a vehicle powertrain structure and, in particular, to a powertrain structure that includes a travel motor and a power converter.

### BACKGROUND ART

In recent years, vehicles that include a motor as a drive source for travel have been increasing. In such vehicles, a battery for supplying electric power to the motor and a power converter that transforms the electric power between the battery and the motor are mounted.

A controller that controls the two motors is disclosed in JP2012-62436A. The controller that is disclosed in JP2012-62436A includes an inverter circuit and a booster circuit. A reactor included in the booster circuit is arranged in a case that accommodates the motor. In this way, a portion of the controller accommodating the inverter circuit and components of the booster circuit other than the reactor is downsized. That is, the relatively large reactor is arranged not in a cover member for accommodating the inverter circuit and the like but in the case for accommodating the motor. In this way, the controller disclosed in JP2012-62436A is downsized as a whole.

An inverter that transforms the electric power between the motor as the drive source for vehicle travel and the battery is disclosed in JP6070444B2. In the inverter disclosed in JP6070444B2, all circuit components that constitute the inverter are accommodated in a case for accommodating a transmission mechanism. In JP6070444B2, since all of the circuit components of the inverter are accommodated not in an inverter case but in the case for the transmission mechanism, the number of the components can be reduced.

### SUMMARY OF INVENTION

### Technical Problem

However, in the related art that includes the techniques disclosed in JP2012-62436A and JP2012-62436A, it is considered to be difficult to establish an electromagnetic compatibility (EMC) measure and ensure safety during a vehicle collision at the same time. More specifically, a direct current (DC) wire that connects the controller and the battery is not disclosed in JP2012-62436A. Thus, depending on an arrangement configuration of the DC wire, the DC wire can possibly be damaged during the vehicle collision, which possibly causes a problem from a viewpoint of ensuring safety.

In the inverter disclosed in JP6070444B2, a power supply connector is provided to a lid body that closes an upper opening of the case, and the DC wire that connects the power converter and the battery via the power supply connector is arranged. That is, in the configuration disclosed in JP6070444B2, it is considered that the DC wire may be damaged during the vehicle collision depending on the arrangement configuration of the DC wire. Furthermore, a configuration in which a noise filter is interposed in the DC wire is not disclosed in JP6070444B2. Moreover, due to where the battery is placed, a length of the DC wire is frequently increased on the outside of the case. For these reasons, there are concerns that problems caused by an influence of electromagnetic waves on other devices and an influence of the electromagnetic waves from other devices may occur with the inverter disclosed in JP6070444B2.

The invention has been made to solve the problem as described above and therefore has a purpose of providing a vehicle powertrain structure capable of establishing an EMC measure and ensuring safety during a vehicle collision at the same time.

### Solution to Problem

A vehicle powertrain structure according to an aspect of the invention includes: a drive system that has a motor as a drive source for travel of a vehicle and a drive system housing formed by using a conductive material and accommodating at least the motor; a battery as a power source of the motor; and a power converter that has a circuit section interposed between the motor and the battery and converting power between the motor and the battery and a converter housing formed by using a conductive material and accommodating the circuit section. In the vehicle powertrain structure according to this aspect, the converter housing is closely joined to the drive system housing or integrally provided with the drive system housing, and, in the drive system housing, a direct current (DC) connector, to which a wire extending from the battery is connected, is disposed in a wall portion, and a DC wire for connecting the circuit section of the power converter to the DC connector and a noise filter inserted in the DC wire are accommodated.

In the vehicle powertrain structure according to the above aspect has the noise filter inserted in the DC wire. Accordingly, noise generated in the power converter is prevented from being leaked to the wire on a DC connector side from the noise filter in the DC wire and on a battery side from the DC connector, thereby providing an electromagnetic interference (EMI) measure. In addition, even in the case where the noise from another device is transmitted to the wire from the battery to the DC connector, interference of the noise with driving of the power converter is prevented, thereby providing an electromagnetic susceptibility (EMS) measure.

In the vehicle powertrain structure according to the above aspect, the DC wire is accommodated in the drive system housing formed of the conductive material. Accordingly, radiation of an electromagnetic wave from a power converter side of the noise filter in the DC wire to the outside of the housing is prevented, and interference of the electromagnetic wave with the DC wire from the outside of the housing is also prevented. Thus, in the vehicle powertrain structure according to the above aspect, an electromagnetic compatibility (EMC) measure is established.

In the vehicle powertrain structure according to the above aspect, the noise filter is not accommodated in the converter housing but is accommodated in the drive system housing that is closely joined or integrally formed with the converter housing. Accordingly, in the vehicle powertrain structure according to the above aspect, it is possible to downsize the converter housing by a space corresponding to the noise filter, and it is thus possible to suppress a collision of the converter housing with a portion therearound during the vehicle collision.

In the vehicle powertrain structure according to the above aspect, since the DC wire is accommodated in the drive system housing having relatively high rigidity, it is possible to suppress damage to the DC wire during the vehicle collision. Accordingly, in the vehicle powertrain structure according to the above aspect, the DC wire can be protected at least until power supply is interrupted even during the vehicle collision. Thus, it is possible to ensure high safety.

In the above description, “closely joined” indicates that, even in the case where a minute clearance is provided in the joined portion between the drive system housing and the converter housing, electromagnetic waves do not pass through the clearance. In addition, “power conversion” executed by the circuit section of the power converter indicates conversion between DC power and alternating current (AC) power, conversion to increase or reduce a voltage, or the like.

In the vehicle powertrain structure according to the above aspect, the converter housing may be placed on at least a part of an upper portion of the drive system housing, and may be formed in a tapered shape in a plan view from above such that a width of a rear end portion is reduced from an outer side to an inner side in a vehicle width direction from a front side toward a rear side.

In the vehicle powertrain structure according to the above aspect, since the rear end portion of the converter housing is formed in the tapered shape as described above, the collision of the converter housing with a peripheral portion is suppressed even during the vehicle collision. That is, during the vehicle collision (in particular, during an offset collision), there is a case where the converter housing rotates together with the driver system housing in the plan view. In such a case, in the case where the rear end portion of the converter housing is not tapered as described above, there is a high risk of a corner portion of the rear end portion colliding with a peripheral member (e.g., a framework member, an auxiliary machine, or the like), and thus there is a concern that the power converter is damaged.

Meanwhile, in the vehicle powertrain structure according to the above aspect, since the rear end portion of the converter housing has the tapered shape as described above, it is possible to reduce the risk of the rear end portion of the converter housing colliding with the peripheral member (such as a member disposed behind the power converter) even during the vehicle collision such as an offset collision. Thus, the vehicle powertrain structure according to the above aspect is advantageous to ensure the high safety during the vehicle collision.

In the vehicle powertrain structure according to the above aspect, in the plan view from above, a DC input/output unit, which is a connection portion of the power converter with the DC wire, and the noise filter may be disposed in an overlapping positional relationship.

In the vehicle powertrain structure according to the above aspect, since the DC input/output unit in the power converter and the noise filter accommodated in the drive system housing are provided to overlap each other in the plan view from above, the converter housing is prevented from protruding from a contour of the drive system housing in the plan view while the rear end portion of the converter housing has the tapered shape as described above. Accordingly, in the vehicle powertrain structure according to the above aspect, it is possible to suppress the power conversion housing from colliding with the peripheral member before the collision of the drive system housing during the vehicle collision, and it is thus further advantageous to ensure the high safety during the vehicle collision.

In the vehicle powertrain structure according to the above aspect, a power line for supplying DC power to an auxiliary machine may be accommodated in the drive system housing, and, in the drive system housing, a branch portion in which the power line is branched on the DC connector side from a position at which the noise filter is inserted in the DC wire may be provided.

In the vehicle powertrain structure according to the above aspect, the branch portion is provided at the above-described position in the DC wire, and the power line is branched in the branch portion. Accordingly, the noise generated in the power converter is prevented from being transmitted through the power line. In addition, since the power line is also accommodated in the drive system housing, the electromagnetic wave from the outside of the housing is also prevented from being transmitted through the power line. Thus, the vehicle powertrain structure according to the above aspect is advantageous to take the further reliable EMC measure.

In the vehicle powertrain structure according to the above aspect, the drive system housing may accommodate an AC wire that connects the circuit section of the power converter and the motor, a drive-system-side DC connector and a drive-system-side AC connector may be disposed in the wall portion of the drive system housing, the drive-system-side DC connector being a connection portion of the DC wire with the circuit section, and the drive-system-side AC connector being a connection portion of the AC wire with the circuit section, a converter-side DC connector and a converter-side AC connector may be disposed in a wall portion of the converter housing, the converter-side DC connector being a connection portion of the circuit section with the DC wire, and the converter-side AC connector being a connection portion of the circuit section with the AC wire, and the drive-system-side DC connector and the converter-side DC connector may be joined and the drive-system-side AC connector and the converter-side AC connector may be joined by slidingly moving the power converter relative to the drive system.

In the vehicle powertrain structure according to the above aspect, the converter-side DC connector and the drive-system-side DC connector, and the converter-side AC connector and the drive-system-side AC connector are configured to be coupled to each other by slidingly moving the drive system and the power converter. Thus, the power converter and the drive system can easily be attached and detached at the time of manufacturing or maintaining the power unit.

In the vehicle powertrain structure according to the above aspect, when the DC wire is seen in a direction intersecting both an up-down direction and a direction of the sliding movement, the DC wire may be routed to undulate in the direction of the sliding movement.

In the vehicle powertrain structure according to the above aspect, the DC wire is routed to undulate when seen in the intersecting direction. Accordingly, compared to a case where the DC wire is routed linearly in an up-down direction from the power converter to the DC connector, it is possible to suppress a vertical dimension of a region where the DC wire is accommodated in the drive system. Thus, the vehicle powertrain structure according to the above aspect is advantageous to reduce the size of the entire powertrain in the up-down direction.

In the vehicle powertrain structure according to the above aspect, the drive system may further include a transmission that is coupled to an output shaft of the motor, the drive system housing is configured to also accommodate the transmission, and the converter housing may be fixed to a portion of the drive system housing, in which the transmission is accommodated, via a bracket.

In the vehicle powertrain structure according to the above aspect, the converter housing is fixed to the portion of the drive system housing, in which the transmission is accommodated, via the bracket. Accordingly, the converter housing and the drive system housing are further firmly joined to each other not only by joining the connectors due to the sliding movement but also by fixing the housings via the bracket. Thus, it is possible to avoid an occurrence of a situation where the drive system housing and the converter housing are separated from each other due to vibration during the vehicle travel, an impact during the vehicle collision, or the like.

In the vehicle powertrain structure according to the above aspect, the drive system and the power converter may be mounted in the powertrain compartment provided in the front portion of the vehicle, the battery may be mounted in a portion of the vehicle on a rear side of the powertrain compartment, and the DC connector may be disposed in the wall portion on a rear side of the drive system housing.

In the vehicle powertrain structure according to the above aspect, the drive system and the power converter are mounted in the powertrain compartment provided in the front portion of the vehicle, and the DC connector is disposed in the rear wall portion of the drive system housing. Accordingly, even during the frontal collision of the vehicle, it is possible to suppress the DC connector from being damaged by an obstacle that enters the powertrain compartment, the member of the vehicle that is pushed by the obstacle and moves rearward, or the like. Therefore, the vehicle powertrain structure according to the above aspect is further advantageous to ensure the high safety during the vehicle collision.

### Advantageous Effects of Invention

In the vehicle powertrain structure according to each of the above aspects, it is possible to establish the EMC measure and ensure the safety during the vehicle collision at the same time.

### BRIEF DESCRIPTION OF DRAWINGS

FIG. 1 is a view illustrating a schematic configuration of a vehicle on which a powertrain according to an embodiment is mounted.

FIG. 2 is a front view in which the powertrain is seen from the front.

FIG. 3 is a plan view in which a part of the powertrain is seen from above.

FIGS. 4A and 4B include views illustrating a configuration of an inverter, in which FIG. 4A is a plan view and FIG. 4B is a right side view.

FIG. 5 is a plan view illustrating a connector and a wire that are included in a motor housing.

FIGS. 6A and 6B include views illustrating a configuration between DC connectors in the motor housing, in which FIG. 6A is a front view and FIG. 6B is a right side view.

FIG. 7 is a right side view illustrating a routing configuration of power lines in a space inside a housing.

FIG. 8 is a view in which section A in FIG. 7 is seen from a left side of the vehicle.

FIGS. 9A and 9B include views illustrating a posture change of the inverter during an offset collision, in which FIG. 9A is a view before the collision and FIG. 9B is a view after the collision.

### DESCRIPTION OF EMBODIMENTS

A description will hereinafter be made on an embodiment of the invention with reference to the drawings. The invention is exemplarily described in the embodiment described below, and the invention is not limited to the following embodiment except for an essential configuration thereof.

In the drawings used in the following description, “FR” indicates a vehicle front direction, “RR” indicates a vehicle rear direction, “LH” indicates a vehicle left direction, “RH” indicates a vehicle right direction, “UP” indicates a vehicle up direction, and “LO” indicates a vehicle down direction.

### 1. Configuration of Vehicle V

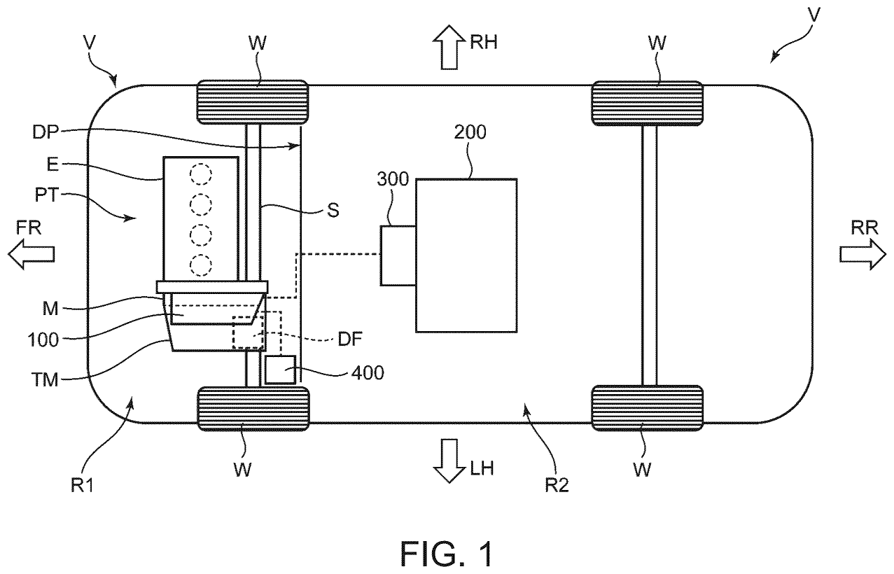

A description will be made on a configuration of a vehicle V according to the embodiment of the invention with reference to FIG. 1.

As illustrated in FIG. 1, in the vehicle V, a powertrain PT that includes an inverter 100 (a type of power converter) is mounted in a front powertrain compartment R1.

The vehicle V is a so-called hybrid electric vehicle (HEV). An engine E and a motor M as drive sources for travel (that is, drive sources for wheels W) are mounted on the vehicle V. The powertrain PT includes a transmission TM in addition to the engine E and the motor M.

The motor M is a three-phase three-wire alternating current (AC) motor that is rotated when being supplied with three-phase AC power, and includes output shaft, a rotor that has a permanent magnet disposed around the output shaft, and a stator that is disposed on an outer periphery of the rotor and in which a coil is wound around each of a plurality of teeth. The plurality of coils include a U-phase coil, a V-phase coil, and a W-phase coil, and a current of a mutually different phase is supplied to the coil of the respective phase.

The transmission TM is connected to the motor M and decelerates the rotation that is input from the motor M. The transmission TM is integrated with a differential gear DF. Thus, the rotation that is input to the transmission TM is output to a driveshaft S via the differential gear DF and is transmitted to the wheels W.

The vehicle V according to the present embodiment is a parallel hybrid electric vehicle as an example, and can travel by a driving force of only the motor M, travel by driving forces of both the motor M and the engine E, and travel by a driving force of only the engine E. The vehicle V can perform deceleration regeneration, and the motor M generates the electric power by a transmission force from the wheels W during deceleration of the vehicle V.

A battery 200 exchanges the electric power with the motor M. When the motor M is driven as the drive source for travel, the battery 200 supplies the electric power to the motor M. In this case, direct current (DC) power is supplied via a DC/DC converter 300 that is provided in a power supply path between the battery 200 and the motor M.

Meanwhile, when the motor M is driven as a generator during the deceleration of the vehicle V, the battery 200 stores the electric power that is generated by the motor M.

The inverter 100 is connected to the three-phase three-wire motor M. The inverter 100 is a power converter that converts the DC power from the battery 200 into AC power and supplies the electric power to the motor M. More specifically, the inverter 100 converts the DC power, which is supplied from the battery 200 via a DC circuit including the DC/DC converter 300, into the three-phase AC power and supplies the three-phase AC power to the motor M.

In the case where the motor M is driven as the generator during the deceleration of the vehicle V, the inverter 100 converts the AC power, which is generated by the motor M, into the DC power and supplies the DC power to the battery 200 via the DC circuit including the DC/DC converter 300.

Although not illustrated in FIG. 1, the vehicle V also includes a low-voltage battery for supplying the electric power to an electrical component provided in each portion of the vehicle V. The low-voltage battery is a battery having a nominal voltage lower than that of the battery 200.

Here, the battery 200 is a lithium-ion battery or a nickel-metal hydride battery having a nominal voltage of 24 V or higher, for example. The low-voltage battery is a lead battery or a lithium-ion battery having a nominal voltage of 12 V or 24 V, for example.

The battery 200 is mounted on a space under a floor of a cabin R2, or the like that is divided backward by a dashboard DP from the powertrain compartment R1.

In the vehicle V, a powertrain control module (PCM) 400 as a controller that comprehensively controls the powertrain PT including the motor M and the engine E is also mounted.

### 2. Arrangement of Inverter 100

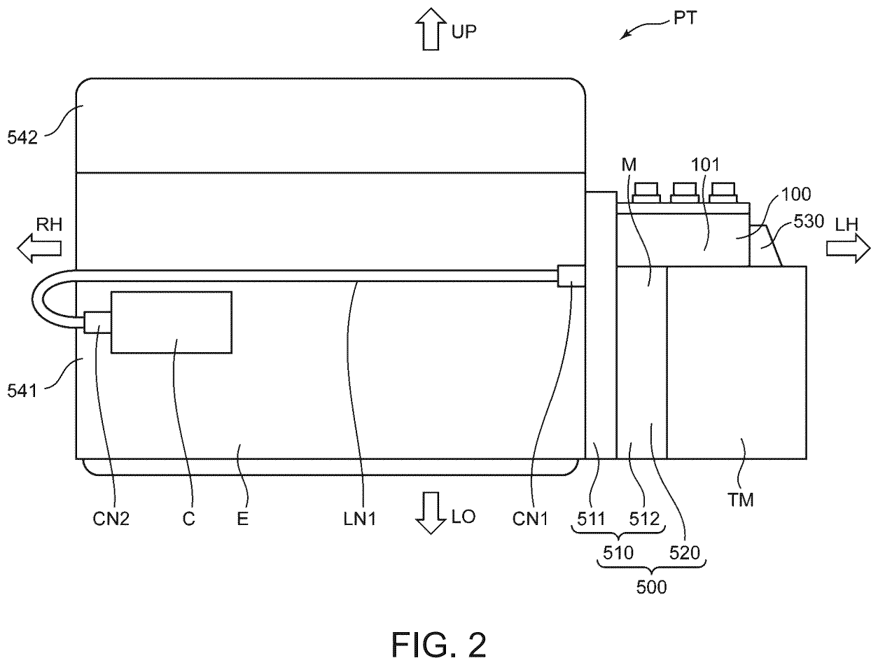

A description will be made on an arrangement of the inverter 100 in the powertrain compartment R1 with reference to FIG. 2. FIG. 2 is a front view in which the powertrain PT including the inverter 100 is seen from the front side of the vehicle V.

As illustrated in FIG. 2, the engine E, the motor M, and the transmission TM are sequentially arranged from right to left in the powertrain compartment R1. The engine E has an engine lower section 541 and an engine upper portion 542 that is disposed on top of the engine lower portion 541.

The motor M is disposed on a left side of and adjacent to the engine lower portion 541 of the engine E, and has a motor housing 510 that includes a first motor housing 511 and a second motor housing 512 as outer shells. The first motor housing 511 is joined to a left side surface of the engine lower portion 541, and the second motor housing 512 is joined to a left portion of the first motor housing 511 without any clearance therebetween. The first motor housing 511 and the second motor housing 512 are each formed by using a conductive material (for example, a metallic material or a carbon fiber reinforced resin).

The transmission TM has an axle housing 520 as an outer shell. The axle housing 520 is joined (fastened) to the left side of the second motor housing 512 in the motor housing 510 without any clearance therebetween. A transmission mechanism that constitutes the transmission TM is accommodated in the axle housing 520. The axle housing 520 is also formed by using the conductive material (for example, the metallic material or the carbon fiber reinforced resin).

In the powertrain PT, the motor housing 510 and the axle housing 520 are combined to constitute a drive system housing 500.

The inverter 100 is arranged adjacent to the first motor housing 511 in a vehicle width direction of the vehicle V and is arranged in a portion extending from an upper portion of the second motor housing 512 to an upper portion of the axle housing 520. The inverter 100 is connected by joining a connector (not illustrated in FIG. 2) that is formed in the first motor housing 511 to a connector (not illustrated in FIG. 2) of the inverter 100. The connectors are joined to each other by slidingly moving the inverter 100 in the right direction with respect to the drive system housing 500.

In addition, the inverter 100 has an inverter housing 101 (converter housing) that constitutes an outer shell. The inverter housing 101 is fixed to the axle housing (a portion of the drive system housing 500 in which the transmission TM is accommodated) 520 via a bracket 530.

An electric compressor C (auxiliary machine) for an air conditioner is also mounted in the powertrain compartment R1 (see FIG. 1) of the vehicle V. The electric compressor C is supplied with the DC power from the battery 200 (see FIG. 1) via a power line harness (power line) LN1. The power line harness LN1 is connected to the DC circuit in the drive system housing 500 by a connector CN1 that is connected to one end, and is connected to the electric compressor C by a connector CN2 connected to the other end.

### 3. Structure and Arrangement of Inverter Housing 101

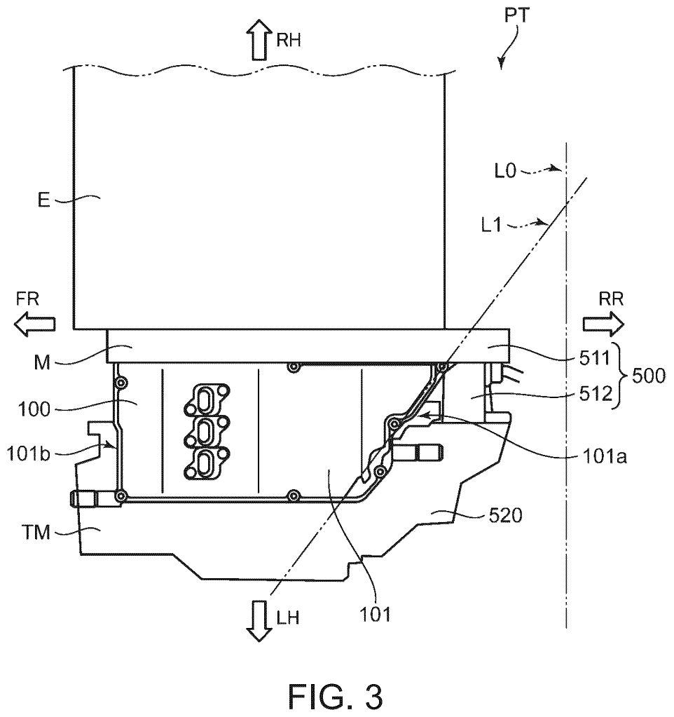

A description will be made on a structure and arrangement of the inverter housing 101 with reference to FIG. 3.

As illustrated in FIG. 3, in the front-rear direction of the vehicle V, a rear end portion 101a of the inverter housing 101 is flush with any of rear end portions of the first motor housing 511, the second motor housing 512, and the axle housing 520, or is arranged in front of any of the rear end portions of the first motor housing 511, the second motor housing 512, and the axle housing 520. More specifically, the rear end portion 101a of the inverter housing 101 is arranged in front of any of the first motor housing 511, the second motor housing 512, and the axle housing 520.

In addition, in the front-rear direction of the vehicle V, a front end portion 101b of the inverter housing 101 is flush with any of front end portions of the first motor housing 511, the second motor housing 512, and the axle housing 520, or is arranged behind any of the front end portions of the first motor housing 511, the second motor housing 512, and the axle housing 520. More specifically, the front end portion 101b of the inverter housing 101 is arranged at a position behind the front end portion of the first motor housing 511 and the front end portion of the axle housing 520. The front end portion 101b of the inverter housing 101 is arranged at a position that is substantially flush with the front end portion of the second motor housing 512.

Furthermore, in a plan view from above, the rear end portion 101a of the inverter housing 101 is formed in a tapered shape such that a width thereof is gradually reduced from the left side (outer side) to the right side (inner side) in the vehicle width direction from the front side toward the rear side. That is, when an imaginary line L1 is drawn along a rear end surface of the rear end portion 101a of the inverter housing 101, the rear end portion 101a of the inverter housing 101 is formed in such a shape that the imaginary line L1 intersects an imaginary line L0 along the vehicle width direction at an angle of less than 90°.

### 4. Detailed Structure of Inverter 100

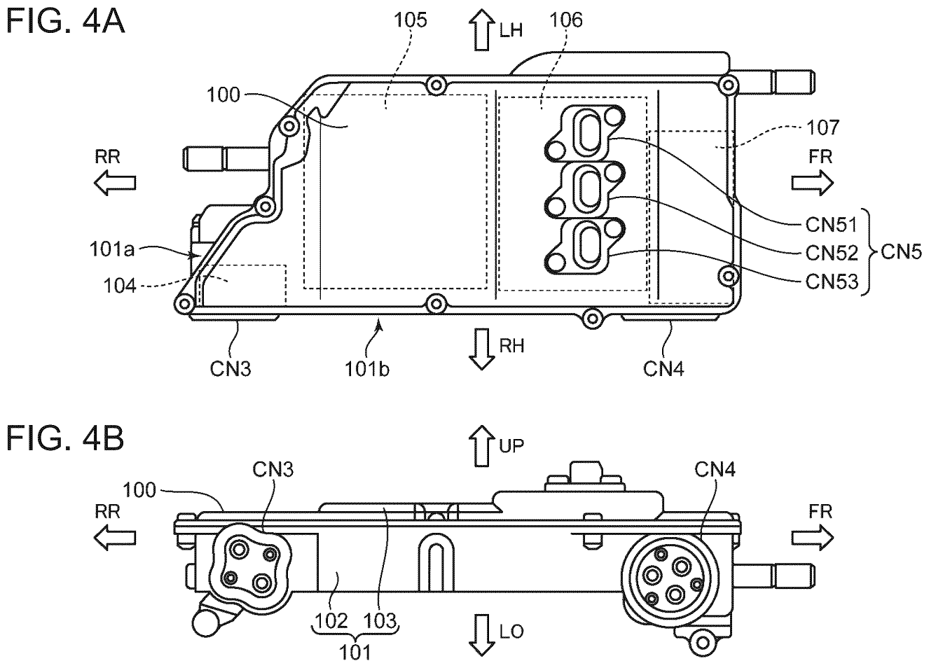

A detailed structure of the inverter 100 will be described with reference to FIG. 4B.

As illustrated in FIG. 4B, the inverter housing 101 of the inverter 100 is configured by combining a housing body 102 and a lid 103. The housing body 102 has an opening in an upper portion thereof, and the lid 103 closes the opening of the housing body 102. The housing body 102 and the lid 103 are each formed by using the conductive material (for example, the metallic material or the carbon fiber reinforced resin).

As illustrated in FIGS. 4A and 4B, in a right wall portion of the housing body 102, a DC connector CN3 (converter-side DC connector) is provided in a rear portion, and an AC connector CN4 (converter-side AC connector) is provided in a front portion. The DC connector CN3 is a connector for connecting the inverter 100 and a DC wire on the battery 200 side, and the AC connector CN4 is a connector for connecting the inverter 100 and an AC wire on the motor M side.

In the lid 103, a plurality (three as an example in the present embodiment) of PCM connectors CN51 to CN53 (hereinafter, collectively described as PCM connectors CN5) are provided in a manner to protrude upward. These PCM connectors CN5 are connectors for connecting the PCM 400 to the inverter 100.

As illustrated in FIG. 4A, the inverter 100 includes a DC input/output unit 104, a smoothing unit 105, a power module unit 106, and an AC input/output unit 107 that are accommodated in the inverter housing 101. The DC input/output unit 104, the smoothing unit 105, the power module unit 106, and the AC input/output unit 107 are sequentially disposed from the front side to the rear side in the front-rear direction of the vehicle V. In the inverter 100, the DC input/output unit 104 is accommodated in the rear end portion 101a of the inverter housing 101 that is formed in the tapered shape.

The smoothing unit 105 is configured to include a smoothing capacitor such as a film capacitor or an electrolytic capacitor. An X capacitor may be disposed in the smoothing unit 105.

The power module unit 106 is configured by an insulated gate bipolar transistor (IGBT). Here, the power module unit 106 does not always have to be configured by the IGBT, and may be configured by a known power module such as a metal oxide semiconductor field effect transistor (MOSFET).

The DC connector CN3 is configured as a part of the DC input/output unit 104, and the AC connector CN4 is configured as a part of the AC input/output unit 107.

Although a detailed description is not made, the inverter housing 101 is also provided with a refrigerant circulation path for cooling the smoothing unit 105 and the power module unit 106.

### 5. Configuration in Motor Housing 510

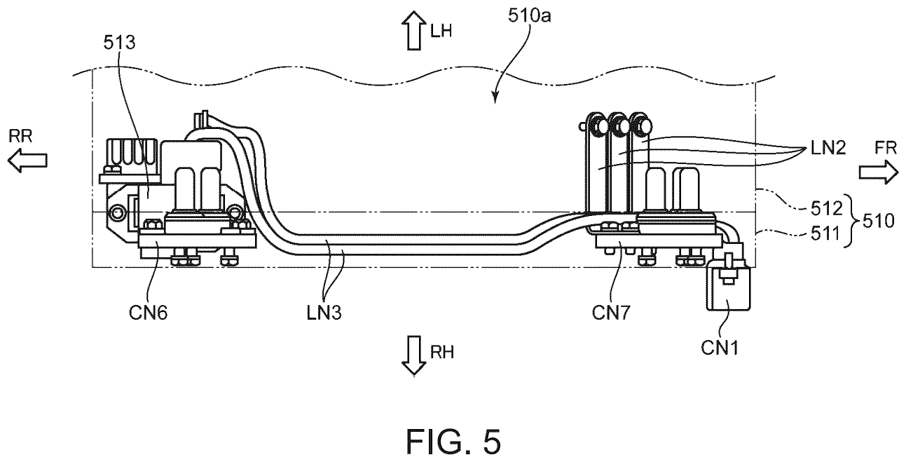

A description will be made on an electric configuration in the motor housing 510 with reference to FIG. 5 to FIG. 8.

As illustrated in FIG. 5, a DC connector CN6 (drive-system-side DC connector) and an AC connector CN7 (drive-system-side AC connector) are provided in a left wall portion of the first motor housing 511. The DC connector CN6 is a connector that is joined to the DC connector CN3 (see FIG. 4B) of the inverter 100, and is provided in the rear portion. The AC connector CN7 is a connector that is joined to the AC connector CN4 (see FIG. 4B) of the inverter 100, and is provided in the front portion.

As described above, the DC connector CN3 and the DC connector CN6 are joined to each other, and the AC connector CN4 and the AC connector CN7 are joined to each other at the same time by horizontally and slidingly moving the inverter housing 101 of the inverter 100 toward the first motor housing 511.

As illustrated in FIG. 5 to FIG. 7, a housing inner space 510a of the motor housing 510 accommodates two DC bus bars LN4 (each an example of a DC wire), a ferrite core 513 (an example of a noise filter), three AC bus bars LN2 (each an example of an AC wire), a power line LN3.

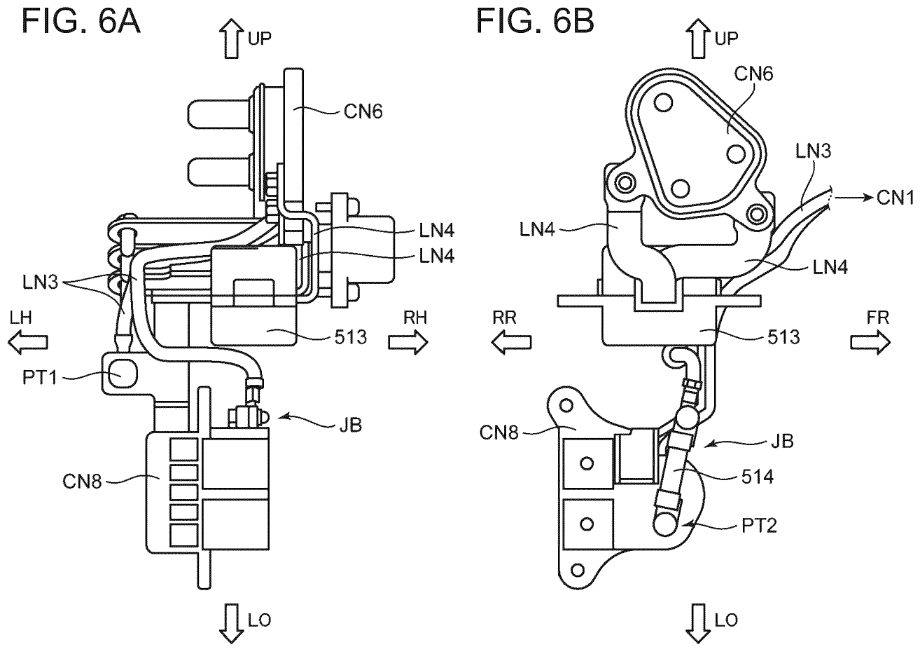

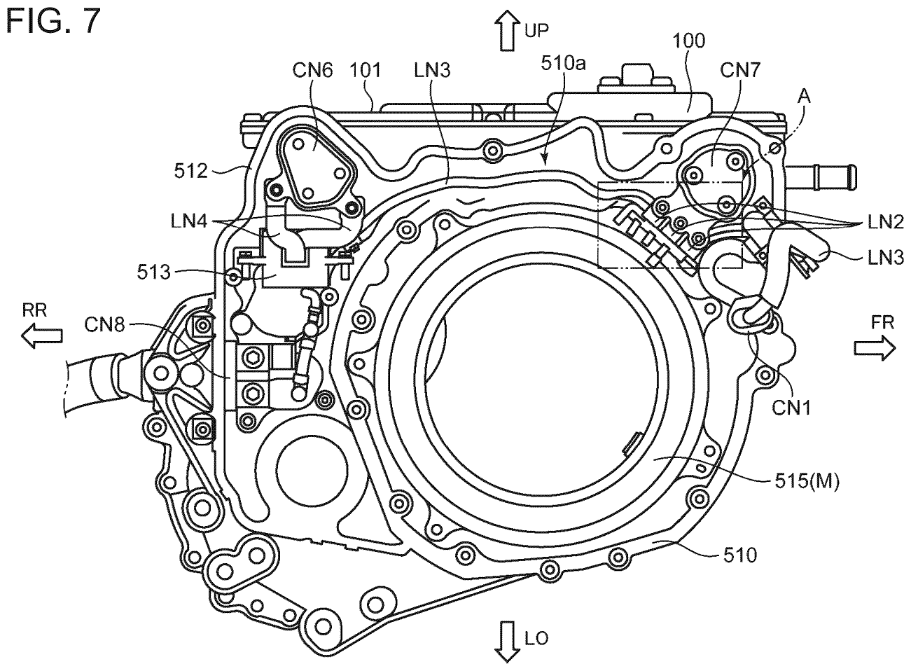

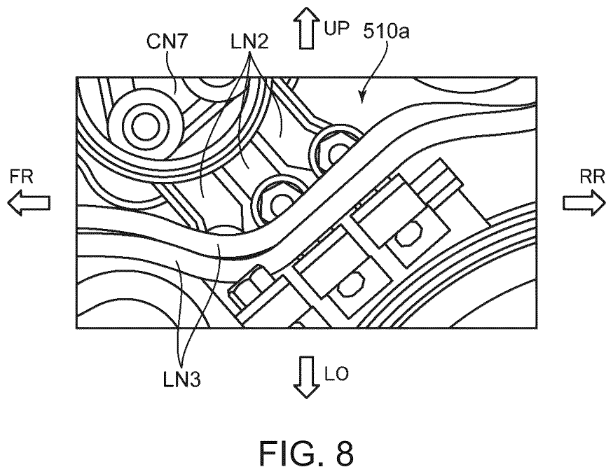

As illustrated in FIG. 6B and FIG. 7, the two DC bus bars LN4 connect between the DC connector CN6 and a DC connector CN8. In addition, as illustrated in FIG. 7 and FIG. 8, the three AC bus bars LN2 connect the AC connector CN7 and a coil of a stator 515 of the motor M.

As illustrated in FIGS. 6A and 6B, the ferrite core 513 is interposed in intermediate portions in a longitudinal direction of the DC bus bars LN4. More specifically, the DC bus bars LN4 are each routed such that the intermediate portion in the longitudinal direction is inserted through a hole of the ferrite core 513. The ferrite core 513 is provided as a measure against noise (electromagnetic compatibility (EMC) measure) in the powertrain PT including the inverter 100.

As illustrated in FIG. 5 and FIG. 7, the power line LN3 connects the DC bus bar LN4 and the connector CN1. As illustrated in FIG. 6A and FIG. 6B, the power line LN3 is branched at a position on the DC connector CN8 side from portions (PT1, PT2) of the DC bus bars LN4 inserted through the ferrite core 513. That is, the power line LN3 is branched in the junction box JB (an example of a branch portion) on the DC connector CN8 side from the portions of the DC bus bars LN4 inserted through the ferrite core 513. Then, the power line LN3 is routed to extend forward in the housing space 510a. The power line LN3 and the connector CN1 are connected in a front portion of the housing inner space 510a. A fuse 514 is interposed between one wire of the power line LN3 and one bus bar of the DC bus bar LN3.

Here, in the present embodiment, the power line LN3 is formed of covered electric wires. Thus, as illustrated in FIG. 7 and FIG. 8, the power line LN3 does not cause a short circuit or the like in a portion intersecting the AC bus bar LN2.

As illustrated in FIG. 6A, each of the DC bus bars LN4 is routed to undulate in the vehicle width direction in the housing inner space 510a. More specifically, each of the DC bus bars LN4 is arranged to undulate between a portion below the DC connector CN6 and a portion on the left side thereof.

As illustrated in FIG. 6A and FIG. 6B, the ferrite core 513 is arranged below the DC connector CN6. Accordingly, in the plan view from above, in a state where the DC connector CN3 of the inverter 100 is joined to the DC connector CN6, the ferrite core 513 is arranged to form an overlapping positional relationship with the DC input/output unit 104 (see FIG. 4A) of the inverter 100.

### 6. Behavior of Power Unit PT During Vehicle Collision

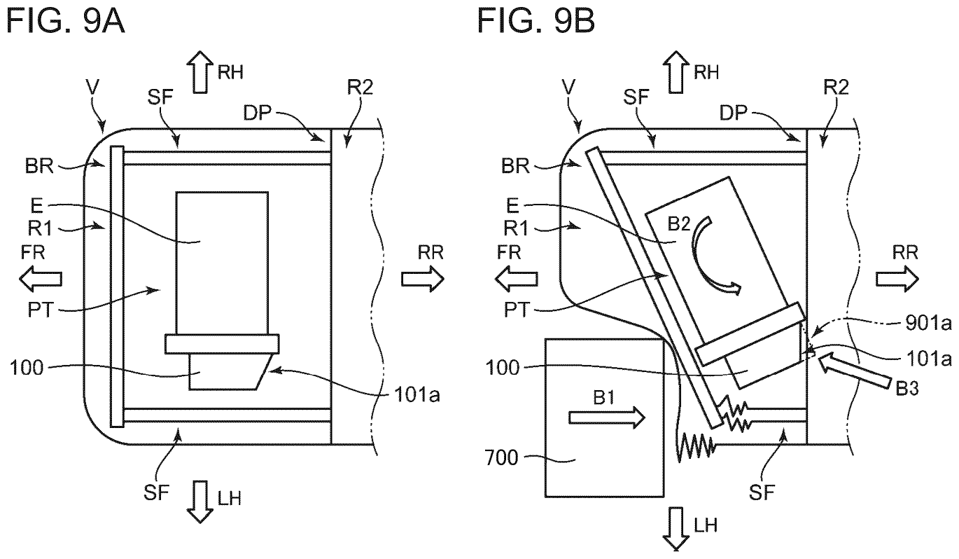

A description will be made on behavior of the power unit PT during a vehicle collision with reference to FIG. 9A and FIG. 9B. A description will hereinafter be made on a case of an offset collision against a front left side of the vehicle V.

As illustrated in FIG. 9A, in the vehicle V according to the present embodiment, the powertrain PT is mounted in the powertrain compartment R1 that is provided in the front portion. In FIG. 9A and FIG. 9B, only the engine E and the inverter 100 of the powertrain PT are illustrated.

In the vehicle V according to the present embodiment, the inverter 100 is arranged on the left side of the engine E in the powertrain compartment R1. Then, the inverter 100 is arranged such that the rear end portion 101a of the inverter housing 101 is located on the vehicle rear side.

Around the powertrain PT, which is mounted in the powertrain compartment R1, a bumper reinforcement BR is disposed on the front side, and a front side frame SF is disposed on each lateral side. The bumper reinforcement BR is disposed to extend in the vehicle width direction, and the front side frame SF is arranged such that a front end thereof is coupled to the bumper reinforcement BR and extends rearward from the coupled portion.

As illustrated in FIG. 9B, in the case of assuming the offset collision of the vehicle V, a collision object 700 (obstacle) enters the powertrain compartment R1 as indicated by an arrow B1. In this case, a left portion of the bumper reinforcement BR is pushed rearward. Consequently, a part of the left front side frame SF is deformed by buckling or the like and thereby absorbs an impact force. In this case, the powertrain PT rotates leftward as indicated by an arrow B2 in the plan view from above.

As illustrated in FIG. 9B, in the case where the powertrain PT rotates as indicated by the arrow B2 due to the offset collision, the rear end portion 101a of the inverter housing 101 approaches the cabin R2 side.

Here, in a comparative example in which, unlike the present embodiment, a rear end portion 901a of an inverter housing is not formed in a tapered shape, it is considered that the rear end portion 901a collides with the dashboard DP as indicated by an arrow B3.

In contrast, in the present embodiment, since the rear end portion 101a of the inverter housing 101 is formed in the tapered shape as described above, the collision of the rear end portion 101a with the dashboard DP is avoided.

### 7. Effects

The structure adopted for the powertrain PT of the vehicle V according to the present embodiment has the ferrite core 513 (noise filter) that is interposed in the DC bus bar LN4 (DC wire). Accordingly, noise generated in the inverter (power converter) is prevented from being leaked to the wire on the DC connector CN8 side from the portion of the DC bus bar LN4 inserted in the ferrite core 513 and on the battery 200 side from the DC connector CN8 (an electromagnetic interference (EMI) measure). In addition, even in the case where the noise is transmitted to the wire from the battery 200 to the DC connector CN8, interference of the noise with driving of the inverter 100 is prevented (an electromagnetic susceptibility (EMS) measure).

In the structure adopted for the powertrain PT of the vehicle V, the DC bus bar LN4 is accommodated in the drive system housing 500 (more specifically, in the motor housing 510) that is formed of the conductive material. Accordingly, radiation of an electromagnetic wave from the inverter 100 side of the portion of the DC bus bar LN4 inserted through the ferrite core 513 to the outside of the drive system housing 500 is prevented, and the interference of the electromagnetic wave with the DC bus bar LN4 from the outside of the drive system housing 500 is also prevented. Thus, the EMC measures are taken against the powertrain structure of the vehicle V.

In the structure adopted for the powertrain PT of the vehicle V, the ferrite core 513 is not accommodated in the inverter housing 101, but the ferrite core 513 is accommodated in the drive system housing 500 that is closely joined to the inverter housing 101. Accordingly, in the structure adopted by the powertrain PT of the vehicle V, it is possible to downsize the inverter housing 101 by a space corresponding to the ferrite core 513, and it is thus possible to prevent the collision of the inverter housing 101 with the portion therearound during the vehicle collision.

In the structure adopted for the powertrain PT of the vehicle V according to the present embodiment, since the DC bus bar LN4 is accommodated in the drive system housing 500 having relatively high rigidity, it is possible to suppress damage to the DC bus bar LN4 during the vehicle collision. Accordingly, in the structure adopted by the powertrain PT of the vehicle V, the DC bus bar LN4 can be protected at least until the power supply is interrupted even during the vehicle collision. Thus, it is possible to ensure high safety.

When it is assumed that the DC bus bar LN4 is disposed outside the drive system housing 500 as in the techniques disclosed in JP2012-62436A and JP2012-62436A, securing a sufficient space to prevent the DC bus bar LN4 from being sandwiched between peripheral members or from strongly colliding with the peripheral member during the vehicle collision is considered, and securing a space to provide a protector for protecting the DC bus bar LN4 is also considered. Even when such a structure is adopted, suppressing the damage to the DC bus bar LN4 that is disposed on the outside of the drive system housing 500 is considered.

However, in the case where the structure in which the DC bus bar LN4 is disposed outside the drive system housing 500 as described above is adopted, it is considered to be difficult to improve a degree of freedom in arrangement of the powertrain PT or to make the vehicle V compact. To handle such a problem, in the structure adopted for the powertrain PT of the vehicle V according to the present embodiment, since the DC bus bar LN4 is accommodated in the drive system housing 500, it is possible to narrow a space for ensuring the safety around the DC bus bar LN4, and it is thus possible to improve the degree of freedom in arrangement of the powertrain PT and to make the vehicle V compact.

As described above, “closely joined” indicates that, even in the case where a minute clearance is provided in the joined portion between the drive system housing 500 and the inverter housing 101, electromagnetic waves do not pass through the clearance.

In the structure adopted for the powertrain PT of the vehicle V according to the present embodiment, since the rear end portion 101a of the inverter housing 101 is formed in the tapered shape as described above, the collision of the inverter housing 101 with the peripheral portion (such as the dashboard DP) is suppressed even during the vehicle collision (see FIG. 9). That is, during the vehicle collision (particularly, during the offset collision), there is a case where the inverter housing 101 rotate together with the drive system housing 500 in the plan view. In such a case, when the rear end portion 101a of the inverter housing 101 does not have the tapered shape as described above (the rear end portion 901a as the comparative example in FIG. 9B), there is a high risk that a corner portion of the rear end portion 901a collides with the peripheral member (such as the dashboard DP), and thus there is a concern that the inverter 100 is damaged.

Meanwhile, in the structure adopted for the powertrain PT of the vehicle V according to the present embodiment, since the rear end portion 101a of the inverter housing 101 has the tapered shape, it is possible to reduce the risk that the rear end portion 101a of the inverter housing 101 collides with the peripheral member (such as the dashboard DP) even during the vehicle collision such as the offset collision. Thus, the structure adopted for the powertrain PT of the vehicle V is advantageous to ensure the high safety during the vehicle collision.

In the structure adopted for the powertrain PT of the vehicle V according to the present embodiment, since the DC input/output unit 104 in the inverter 100 and the ferrite core 513 accommodated in the drive system housing 500 are provided in the overlapping positional relationship in the plan view from above, the inverter housing 101 is prevented from protruding from a contour of the drive system housing 500 in the plan view while the rear end portion 101a of the inverter housing 101 has the tapered shape as described above. Accordingly, in the structure adopted for the powertrain PT of the vehicle V, it is possible to suppress the inverter housing 101 from colliding with the peripheral member before the collision of the drive system housing 500 during the vehicle collision, and it is thus further advantageous to ensure the high safety during the vehicle collision.

In the structure adopted for the powertrain PT of the vehicle V according to the present embodiment, a junction box JB (as shown in FIGS. 6A and 6B) is provided at the position between the portion of the DC bus bar LN4 inserted through the ferrite core 513 and the connection portion with the DC connector CN8, and the power line LN3 is branched by the junction box JB. Thus, the noise generated in the inverter 100 is prevented from being transmitted through the power line LN3. In addition, since the power line LN3 is also accommodated in the drive system housing 500, the electromagnetic wave from the outside of the housing 500 is also prevented from being transmitted through the power line LN3. Thus, the structure adopted for the powertrain PT of the vehicle V is advantageous to take the further reliable EMC measure.

The structure adopted for the powertrain PT of the vehicle V according to the present embodiment is configured to slidingly move the drive system housing 500 (more specifically, the first motor housing 511) and the inverter housing 101 relative to each other in the horizontal direction and thereby join the DC connector CN3 (converter-side DC connector) to the DC connector CN6 (drive-system-side DC connector) and the AC connector CN4 (converter-side AC connector) to the AC connector CN7 (drive-system-side AC connector). Thus, the inverter housing 101 and the drive system housing 500 can easily be attached/detached at the time of manufacturing or maintaining the power unit PT.

In the structure adopted for the powertrain PT of the vehicle V according to the present embodiment, as illustrated in FIG. 6A, the DC bus bar LN4 is routed to undulate in the left-right direction when seen from the side. Accordingly, compared to a case of adopting a structure in which the DC bus bar LN4 is routed linearly from the upper side to the lower side and the ferrite core 513 is interposed in the intermediate portion thereof, it is possible to suppress a vertical dimension of a region where the DC bus bar LN4 is accommodated in the drive system housing 500. Thus, the structure adopted for the powertrain PT of the vehicle V is advantageous to reduce the size of the entire powertrain PT in the up-down direction.

In the structure adopted for the powertrain PT of the vehicle V according to the present embodiment, the inverter housing 101 is fixed to the portion (axle housing 520) of the drive system housing 500, in which the transmission mechanism is accommodated, via the bracket 530. Accordingly, since the inverter housing 101 and the drive system housing 500 are slidingly moved, the inverter housing 101 and the drive system housing 500 are further firmly joined to each other not only by joining the connectors CN3, CN4, CN6, and CN7 but also by fixing the inverter housing 101 and the drive system housing 500 via the bracket 530. Thus, it is possible to avoid an occurrence of a situation in which the drive system housing 500 and the inverter housing 101 are separated from each other due to vibration during the vehicle travel, impact during the vehicle collision, or the like.

In the structure adopted for the powertrain PT of the vehicle V according to the present embodiment, the powertrain PT is mounted in the powertrain compartment R1, which is provided in the front portion of the vehicle V, and the DC connector CN8 is disposed in the rear wall portion of the drive system housing 500. Accordingly, even during a frontal collision of the vehicle V, it is possible to suppress the DC connector CN8 from being damaged by the obstacle that enters the powertrain compartment R1, the member of the vehicle V that is pushed by the obstacle and moves rearward, or the like. Thus, the structure adopted for the powertrain PT of the vehicle V is further advantageous to ensure the high safety during the vehicle collision.

As it has been described so far, with the structure adopted for the powertrain PT of the vehicle V according to the present embodiment, it is possible to establish the EMC measure and ensure the safety during the vehicle collision at the same time.

### Modified Examples

In the above embodiment, such a configuration is adopted that the drive system housing 500 and the inverter housing 101 are separate members and are closely joined to each other. However, in the invention, it is also possible to adopt a configuration that the drive system housing 500 and the inverter housing are integrated. That is, in the invention, a configuration may be adopted that the converter housing is not provided separately from the drive system housing, that a part of the drive system housing has an outwardly bulging portion, and that components of the power converter are accommodated in the bulging portion. In this case, in the configuration of the power converter, it is not always necessary that the components are densely arranged in the housing inner space of the drive system housing, and the components may separately be arranged in the housing space.

In the above embodiment, the inverter 100 is adopted as an example of the power converter. However, in the invention, a device other than the inverter may be adopted as the power converter. For example, a DC/DC converter may be adopted as the power converter.

In the above embodiment, the ferrite core 513 is adopted as an example of the noise filter. However, in the invention, it is also possible to adopt a noise filter other than the ferrite core. For example, a choke coil, a Y capacitor, or the like may be adopted as the noise filter.

In the above embodiment, the wire is connected by joining the socket-type connectors CN1 to CN8. However, in the invention, it is not always necessary to connect the wire by using the socket-type connector. That is, in the present specification, the connector only means a joint portion between the wire, and a joint type thereof is not limited.

In the above embodiment, the rear end portion 101a of the inverter housing 101 is formed in the tapered shape. However, in the invention, it is not always necessary to form the rear end portion of the converter housing in the tapered shape. In relation to the drive system housing, as long as the collision of the converter housing with the peripheral component (such as the dashboard DP) is avoided even during the vehicle collision, the shape of the rear end portion of the converter housing is not limited.

In the above embodiment, such an arrangement configuration that satisfies the overlapping positional relationship between the DC input/output unit 104 of the inverter 100 and the ferrite core 513 in the plan view from above is adopted. However, the invention is not limited thereto. For example, in the case where a sufficient space is secured in the drive system housing, the DC input/output unit and the noise filter may be arranged in a misaligned positional relationship without overlapping each other in the plan view.

In the above embodiment, the junction box JB in which the power line LN3 is branched is disposed in the drive system housing 500. However, in the invention, the junction box JB may be disposed outside of the drive system housing 500.

In the above embodiment, the connectors CN3, CN4, CN6, and CN7 are joined by slidingly moving the inverter housing 101 and the drive system housing 500. However, the invention is not limited thereto. For example, the conductive portions may be connected to each other by fastening the conductive portion formed on a terminal block to the other conductive portion by using a bolt or the like. In addition, the direction of the sliding movement does not always have to be the vehicle width direction, and may be the front-rear direction or an oblique direction (a direction oblique to the front-rear direction and the vehicle width direction) of the vehicle.

In the above embodiment, the inverter housing 101 and the axle housing 520 are fixed via the bracket 530. However, the invention is not limited thereto. For example, the connectors to be joined can be further screwed together, or the converter housing can be secured to the motor housing.

In the above embodiment, the configuration that the powertrain compartment R1 is provided in the front portion of the vehicle V is adopted. However, in the invention, the powertrain compartment can also be provided in the rear portion of the vehicle. In this case, the DC connector, which is the connection portion with the battery, can be disposed in the front wall portion of the drive system housing. By disposing the DC connector just as described, it is possible to ensure the high safety during a rear-end collision.

In the above embodiment, the electric compressor C of the air conditioner is adopted as an example of an auxiliary machine. However, the invention is not limited thereto. For example, a refrigerant pump that circulates a refrigerant for cooling the powertrain PT can be adopted.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### REFERENCE CHARACTER LIST

100: inverter (power converter)
101: inverter housing (converter housing)
101a: rear end portion of housing
200: battery
500: drive system housing
510: motor housing
510a: housing inner space
513: ferrite core (noise filter)
520: axle housing
530: bracket
C: electric compressor (auxiliary machine)
CN8: DC connector
JB: junction box (branch portion)
LN3: power line
LN4: DC bus bar (DC wire)
M: motor
PT: powertrain
V: vehicle

1. A vehicle powertrain structure comprising:
a drive system that has a motor as a drive source for travel of a vehicle and a drive system housing formed by using a conductive material and accommodating at least the motor;
a battery as a power source of the motor; and
a power converter that has a circuit section interposed between the motor and the battery and converting power between the motor and the battery and a converter housing formed by using a conductive material and accommodating the circuit section, wherein
the converter housing is closely joined to the drive system housing or integrally provided with the drive system housing, and
in the drive system housing, a direct current (DC) connector, to which a wire extending from the battery is connected, is disposed in a wall portion, and a DC wire for connecting the circuit section of the power converter to the DC connector and a noise filter inserted in the DC wire are accommodated.

2. The vehicle powertrain structure according to claim 1, wherein
the converter housing is placed on at least a part of an upper portion of the drive system housing, and is formed in a tapered shape in a plan view from above such that a width of a rear end portion is reduced from an outer side to an inner side in a vehicle width direction from a front side toward a rear side.

3. The vehicle powertrain structure according to claim 2, wherein
in the plan view from above, a DC input/output unit, which is a connection portion of the power converter with the DC wire, and the noise filter are disposed in an overlapping positional relationship.

4. The vehicle powertrain structure according to claim 3, wherein
a power line for supplying DC power to an auxiliary machine is accommodated in the drive system housing, and
in the drive system housing, a branch portion in which the power line is branched on a DC connector side from a position at which the noise filter is inserted in the DC wire is provided.

5. The vehicle powertrain structure according to claim 3, wherein
the drive system housing accommodates an alternating current (AC) wire that connects the circuit section of the power converter and the motor,
a drive-system-side DC connector and a drive-system-side AC connector are disposed in the wall portion of the drive system housing, the drive-system-side DC connector being a connection portion of the DC wire with the circuit section, and the drive-system-side AC connector being a connection portion of the AC wire with the circuit section,
a converter-side DC connector and a converter-side AC connector are disposed in a wall portion of the converter housing, the converter-side DC connector being a connection portion of the circuit section with the DC wire, and the converter-side AC connector being a connection portion of the circuit section with the AC wire, and
the drive-system-side DC connector and the converter-side DC connector are joined and the drive-system-side AC connector and the converter-side AC connector are joined by slidingly moving the power converter relative to the drive system.

6. The vehicle powertrain structure according to claim 5, wherein
when the DC wire is seen in a direction intersecting both an up-down direction and a direction of the sliding movement, the DC wire is routed to undulate in the direction of the sliding movement.

7. The vehicle powertrain structure according to claim 5, wherein
the drive system further includes a transmission that is coupled to an output shaft of the motor,
the drive system housing is configured to also accommodate the transmission, and
the converter housing is fixed to a portion of the drive system housing, in which the transmission is accommodated, via a bracket.

8. The vehicle powertrain structure according to claim 3, wherein
the drive system and the power converter are mounted in a powertrain compartment that is provided in a front portion of the vehicle,
the battery is mounted in a portion of the vehicle on a rear side of the powertrain compartment, and
the DC connector is disposed in the wall portion on a rear side of the drive system housing.

9. The vehicle powertrain structure according to claim 1, wherein
a power line for supplying DC power to an auxiliary machine is accommodated in the drive system housing, and
in the drive system housing, a branch portion in which the power line is branched on a DC connector side from a position at which the noise filter is inserted in the DC wire is provided.

10. The vehicle powertrain structure according to claim 1, wherein
the drive system housing accommodates an alternating current (AC) wire that connects the circuit section of the power converter and the motor,
a drive-system-side DC connector and a drive-system-side AC connector are disposed in the wall portion of the drive system housing, the drive-system-side DC connector being a connection portion of the DC wire with the circuit section, and the drive-system-side AC connector being a connection portion of the AC wire with the circuit section,
a converter-side DC connector and a converter-side AC connector are disposed in a wall portion of the converter housing, the converter-side DC connector being a connection portion of the circuit section with the DC wire, and the converter-side AC connector being a connection portion of the circuit section with the AC wire, and
the drive-system-side DC connector and the converter-side DC connector are joined and the drive-system-side AC connector and the converter-side AC connector are joined by slidingly moving the power converter relative to the drive system.

11. The vehicle powertrain structure according to claim 1, wherein
the drive system and the power converter are mounted in a powertrain compartment that is provided in a front portion of the vehicle,
the battery is mounted in a portion of the vehicle on a rear side of the powertrain compartment, and
the DC connector is disposed in the wall portion on a rear side of the drive system housing.

12. The vehicle powertrain structure according to claim 2, wherein
a power line for supplying DC power to an auxiliary machine is accommodated in the drive system housing, and
in the drive system housing, a branch portion in which the power line is branched on a DC connector side from a position at which the noise filter is inserted in the DC wire is provided.

13. The vehicle powertrain structure according to claim 2, wherein
the drive system housing accommodates an alternating current (AC) wire that connects the circuit section of the power converter and the motor,
a drive-system-side DC connector and a drive-system-side AC connector are disposed in the wall portion of the drive system housing, the drive-system-side DC connector being a connection portion of the DC wire with the circuit section, and the drive-system-side AC connector being a connection portion of the AC wire with the circuit section,
a converter-side DC connector and a converter-side AC connector are disposed in a wall portion of the converter housing, the converter-side DC connector being a connection portion of the circuit section with the DC wire, and the converter-side AC connector being a connection portion of the circuit section with the AC wire, and
the drive-system-side DC connector and the converter-side DC connector are joined and the drive-system-side AC connector and the converter-side AC connector are joined by slidingly moving the power converter relative to the drive system.

14. The vehicle powertrain structure according to claim 2, wherein
the drive system and the power converter are mounted in a powertrain compartment that is provided in a front portion of the vehicle,
the battery is mounted in a portion of the vehicle on a rear side of the powertrain compartment, and
the DC connector is disposed in the wall portion on a rear side of the drive system housing.
